(19) United States
(12) Patent Application Publication
(10) Pub. No.: US 2009/0207876 A1
(43) Pub. Date: Aug. 20, 2009

(54) Laser Source for the Infrared Wavelength Range

(76) Inventors: Markus Henriksson, Linköping (SE); Fredrik Laurell, Danderyd (SE); Valdas Pasiskevicius, Lidingö (SE)

Correspondence Address: JACOBSON HOLMAN PLLC, 400 SEVENTH STREET N.W., SUITE 600, WASHINGTON, DC, 20004, US

(21) Appl. No.: 12/084,296

(22) PCT Filed: Oct. 31, 2006
(86) PCT No.: PCT/SE2006/001228

§ 371 Date: Feb. 11, 2009

(30) Foreign Application Priority Data
Oct. 31, 2005 (SE) 0502396-5

(51) Int. Cl. H01S 3/08; G02B 5/32

(52) U.S. Cl. 372/102; 359/15

(57) ABSTRACT

The present invention relates to a laser source for the infrared wavelength range which comprises a pump laser (1) which emits radiation (PP) which is input radiation to a first optical parametric oscillator (3, 4, 5), whose output radiation (SP) is input radiation to a second step in the form of a second optical parametric oscillator (7, 8, 9) or an optical parametric generator. At least one of the reflective devices of the first optical parametric oscillator consist of a Bragg grating (5) in a bulk material.

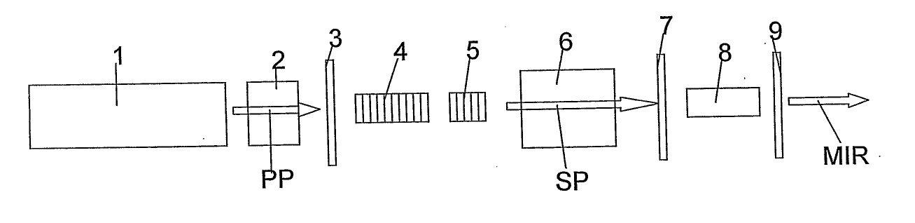

The present invention relates to a laser source for the infrared wavelength range, especially a laser source for generating electromagnetic radiation in the medium- and long-wave infrared wavelength range.

The laser wavelength ranges 2-5 and 8-12 μm are of interest in many applications, for example atmospheric characterisation by LIDAR (Light Detection And Ranging) for aerosol detection and DIAL (Differential Absorption Lidar) for detection of gases, as well as DIRCM (Directed Infra-Red Counter-Measures) for jamming infrared-homing missiles. In particular the wavelengths above 4 μm are difficult to generate.

In parametric processes in optically non-linear materials, it is possible to convert light or other electromagnetic radiation of one wavelength (referred to as the pump) into light or radiation of two other wavelengths (referred to as the signal and the idler). This can take place in the form of optical parametric oscillators (OPO), optical parametric generators (OPG) or optical parametric amplifiers (OPA), where use is made of second-order optical nonlinearity in the non-linear crystal. For effective conversion, the process must be phase matched. This can take place either using birefringent phase matching or using quasi-phase-matching. By selecting the wavelength of the pump and designing the phase matching correctly, it is possible to create radiation of arbitrary wavelengths which are more long-wave than the wave-length of the pump.

In an OPO, the non-linear crystal is placed in a beam path between reflecting mirrors so that radiation generated in the crystal passes repeatedly through the crystal. In the simplest case, the beam path is straight between two parallel mirrors. Radiation is coupled out of the OPO by one of the mirrors being partially transparent for one of or both the wavelengths generated in the OPO. However, OPOs with different forms of more complicated beam paths which comprise a plurality of mirrors are also known. The beam path is then folded in some respect. The function of these OPOs is, however, the same as that of the simplest OPO. Radiation is coupled out of the OPO by means of one of the mirrors.

The best pump lasers are neodymium-doped crystal lasers, for instance Nd:YAG, Nd:YLF and Nd:YVO₄, which all emit wavelengths around 1.06 μm. From these, conversion into wavelengths up to 4 μm can take place in one OPO step with non-linear crystals such as KTP (KTiOPO₄), KTA (KTiOAsO₄), and PPLN (Periodically poled LiNbO₃). Above 4 μm, all these crystals absorb, and it is therefore difficult to achieve high efficiency.

For the longer wavelengths, the crystal material ZGP (ZnGeP₂) is in most cases used instead. This material suffers from the drawback that it cannot be pumped with wavelengths shorter than 2 μm due to absorption. There are alternatives, for instance AGS (AgGaS₂), AGSe (AgGaSe₂) and GaSe, but they all have problems with thermal or mechanical properties. A new promising crystal for quasi-phase-matching (QPM) is OP-GaAs (Orientation Patterned GaAs). This, too, must be pumped at longer wavelengths due to high two-photon absorption at 1 μm.

For pumping ZGP-OPOs, there are two groups of laser sources. Either use is made of holmium-doped laser materials which emit just above 2 μm, but then efficient energy transfer from diodes is difficult to achieve, or an OPO is used to generate the laser radiation that is to pump the next OPO. Prior art systems use OPOs which utilise birefringence in the non-linear crystal for phase matching. This is disadvantageous since it is not possible to use the crystal directions that have the highest non-linear coefficients and walk-off limits the effective interaction length. In conversion from 1.06 μm into 2 μm, one will also be close to the degenerate point, which causes problems with large bandwidth due to low dispersion and problems with stability since it is difficult to design the reflectance of the mirrors for signal and idler separately using coating techniques. Quasi-phase-matching which uses the highest non-linearity and avoids walk-off has especially low dispersion and therefore results in extremely broad-band radiation close to the degenerate point. As a result, there is currently a lack of efficient narrow-band pump sources above 2 μm.

An efficient OPO pump must, however, have a narrow bandwidth. Various methods have been used to reduce the bandwidth of OPOs. However, most methods either cause great loss or result in a complicated system.

Bragg gratings in bulk material have recently become available. The band-width of such gratings can be made very small since the bandwidth is inversely proportional to the number of refractive index planes in the grating. The reflectance of the grating is determined by the number of refractive index planes and the size of the refractive index modulation. Such Bragg gratings are used commercially to stabilise the wave-length of diode lasers for laser pumping.

Other reported applications involve wavelength locking of a thulium laser and in a narrowband OPO in the near IR.

The present invention provides a new solution to the problem of creating a laser source for the infrared wavelength range. This takes place with a tandem coupling, where a first OPO of a special design pumps a second OPO or an OPG. This takes place especially by the invention being designed in the fashion as is evident from the independent claim. The remaining claims define advantageous embodiments of the invention.

The invention will in the following be described in more detail with reference to the accompanying drawing, which illustrates a laser source according to an embodiment of the invention.

The beam path in a traditional OPO is reflected by two or more mirrors. The basic concept of the present invention is to replace one of the mirrors with a Bragg grating in a bulk material. This means that the bandwidth of the generated radiation will be determined by the reflectance bandwidth of the used Bragg grating and not by the gain profile in the non-linear process. An OPO where a Bragg grating constitutes one reflector in the cavity thus makes it possible to use quasi-phase-matching, which allows effective conversion. At the same time the Bragg grating provides a narrow bandwidth of the generated radiation in the 2 μm range so that it can be used for pumping a second OPO or an OPG for generating longer wavelengths.

One embodiment of the invention that will now be discussed with reference to the figure starts with an electro-optical or acousto-optical Q-switched Nd:YAG pump laser. Alternative laser materials for the range 1.0 to 1.08 μm are for example Nd:YLF, Nd:YVO₄, Nd:YALO, Yb-doped crystals such as KGW, KYW, KLuW, CaF₂, YAG, GdCOB, YCOB and BOYS or YB:fiber laser. The pump laser is represented by block 1 in the figure. The laser emits radiation called primary pump, PP, consisting of short pulses, in the current design at 1064 nm wavelength.

The laser is focused by an optical device 2, in the example a lens, to a focus in an optically non-linear crystal 4. In the current embodiment of the invention, the crystal is PPKTP (Periodically Poled KTiOPO₄). Alternatives are, for example, periodically poled crystals of LiNbO₃, MgO:LiNbO₃, KTA (KTiOAsO₄), RTP (RbTiOPO₄), RTA (RbTiOAsO₄) or Rb:KTP. The latter crystal is presented in more detail in Q Jiang et al.: Rb-doped potassium titanyl phosphate for periodic ferroelectric domain inversion, Journal of Applied Physics 92, 2717-(2002). Further alternatives are periodically poled chalcogenide glass materials in bulk or fibre form. Such materials are presented in more detail in M Guignard et al., Second-harmonic generation of thermally poled chalcogenide glass, Optics Express, 13, 789-, (2005). The period of the domain grating created by periodic poling and the temperature in the crystal are selected so that phase matching for the transition from the primary pump to the wavelength that is resonant in the Bragg grating 5 is obtained.

The crystal 4, the Bragg grating 5 and a mirror 3 form, in the figure, the first OPO. In the example, the Bragg grating is used, not only to provide a narrow bandwidth, but also to couple radiation out of the OPO, which is an obvious configuration. However, it is also possible in a more complicated beam path to let a partially transparent mirror handle the out-coupling. The Bragg grating is then used merely to provide a narrow bandwidth of the radiation.

Two wavelengths are generated in the OPO, one which is resonant in the Bragg grating, referred to as signal, and another wavelength, referred to as idler, which is such that the sum of the frequencies of the signal and the idler is equal to the frequency of the primary pump. Traditionally, the shorter of the generated wavelengths is referred to as signal, but there is nothing to prevent that the longer wavelength is resonant in the Bragg grating.

In the embodiment shown in the figure, which has been tested experimentally, the wavelength of the signal was 2008 nm. In a special configuration, the OPO is exactly degenerated and the signal and the idler are identical and equal to the double pump wavelength.

The mirror 3 is transparent for the primary pump and reflective for the signal. The mirror may also, but does not have to, be reflective for the idler. The reflective surface can be flat or concave.

The Bragg grating 5 is treated so that there will be no back reflection from the surfaces in the beam direction, which may occur by anti-reflection coating of the surfaces for signal and idler or by oblique polishing of the surfaces. In one embodiment of the invention, the Bragg grating is holographically written in a photosensitive glass material. Such Bragg gratings are commercially available from, inter alia, ONDAX, Inc. (www.ondax.com) and OptiGrate (www.optigrate.com ). For the primary pump, the surfaces can be reflective, double passage pump configuration, or anti-reflective, single passage pump configuration. The refractive index structures forming the Bragg grating can be flat or concave.

The surfaces of the non-linear crystal 4 may, but do not have to, be anti-reflection coated for the three wavelengths involved. The mirror 3 and the Bragg grating 5 are aligned so that the cavity is resonant for the signal.

The one of the signal and the idler that is intended to be used to pump the second step of the laser source, in the form of a second OPO or an OPG, is referred to as Secondary Pump, SP. The secondary pump is focused by an optical device 6 in the second optically non-linear crystal 8. The entire focusing, or part thereof, can be provided by the glass surfaces of the Bragg grating 5 being curved. The optical device also filters off undesirable wavelengths, especially the remaining primary pump since this may otherwise be absorbed in the non-linear crystal and damage it. In one embodiment of the invention, the optical device 6 consisted of a lens and an interference filter.

In the figure, the second step consists of a second OPO with a non-linear crystal 8 in the form of a ZGP crystal and two mirrors. One mirror 7 transmits the secondary pump and reflects the generated wavelengths, which are signal and idler for the second OPO, and the other mirror 9 is partially transmissive for at least signal or idler. The generated radiation, referred to as MIR, may consist of signal, idler or both and can be tuned by changing the phase matching in the OPO. Alternative non-linear crystals for the second OPO are, for example, AGS (AgGaS₂), AGSe (AgGaSe₂) and CdSe, and for quasi-phase-matching structures of, for example, GaAs, GaP and ZnSe.

In certain cases, it is desirable for the output signal from the laser source to be narrow-band, which is applicable for example in spectroscopy. In this case, it may be convenient to provide also the second OPO with a Bragg grating instead of a mirror, thereby achieving narrow linewidth and tunability.

1. A laser source for the infrared wavelength range comprising a pump laser (1) which emits radiation (PP) which is input radiation to a first optical parametric oscillator (3, 4, 5), whose output radiation (SP) is input radiation to a second step in the form of a second optical parametric oscillator (7, 8, 9) or an optical parametric generator, which second step emits the radiation that is the output radiation (MIR) of the laser source, characterised in that one of the reflective devices of the first optical parametric oscillator is designed as a Bragg grating (5) in a bulk material.

2. A laser source as claimed in claim 1, characterised in that said output radiation (SP) from the first optical parametric oscillator (3, 4, 5) is transmitted through said Bragg grating (5).

3. A laser source as claimed in claim 1, characterised in that also one of the reflective devices of the second optical parametric oscillators (7, 8, 9) is designed as a Bragg grating in a bulk material.

4. A laser source as claimed in claim 1, characterised in that the first optical parametric oscillator (3, 4, 5) uses quasi-phase-matching in a periodically poled material.

5. A laser source as claimed in claim 1, characterised in that said Bragg grating/Bragg gratings (5) is/are made by holographic writing in photosensitive glass material.
